(19) United States
(12) Patent Application Publication
(10) Pub. No.: US 2025/0358715 A1
(43) Pub. Date: Nov. 20, 2025

(54) SHARING SYSTEM INFORMATION UPDATES ON A MULTIPLE SIM/eSIM WIRELESS DEVICE

(71) Applicant: Apple Inc., Cupertino, CA (US)

(72) Inventors: Kai ZHANG, Beijing (CN); Lele CUI, Beijing (CN); Deepankar BHATTACHARJEE, Milpitas, CA (US); Ajay SINGH, San Jose, CA (US)

(21) Appl. No.: 19/119,541

(22) PCT Filed: Dec. 1, 2022
(86) PCT No.: PCT/CN2022/135891

§ 371 Date: Apr. 9, 2025

(51) Int. Cl. H04W 48/10; H04W 76/27; H04W 88/06

(52) U.S. Cl. CPC H04W 48/10; H04W 76/27; H04W 88/06

(57) ABSTRACT

Embodiments described herein relate to sharing system information (SI) updates on a wireless device that supports multiple subscriber identity modules (SIMs) and/or electronic SIMs (eSIMs). The wireless device connects to a cell of a radio access network shared between two different 5G NR cellular wireless networks managed for two different mobile network operators. The wireless device receives an SI change indication in a first broadcast control channel (BCCH) modification cycle via a first SIM or eSIM and subsequently receives updated SI values, using either the first SIM or eSIM or a second SIM or eSIM depending on connectivity states of the wireless device to the cell. Updated SI values are received via broadcast messages and/or in response to SI request messages on demand and stored in a memory shared by both the first SIM or eSIM and the second SIM or eSIM.

### FIELD

The described embodiments relate to wireless communications, including methods and apparatus to share system information (SI) updates on a wireless device that supports multiple subscriber identity modules (SIMs) and/or electronic SIMs (eSIMs).

### BACKGROUND

Many wireless devices are configured to use removable Universal Integrated Circuit Cards (UICCs) that enable the wireless devices to access services provided by Mobile Network Operators (MNOs), which may also be referred to as carriers. Each UICC includes a microprocessor and a read-only memory (ROM), where the ROM is configured to store a subscriber identity module (SIM) profile that the wireless device can use to register and interact with an MNO to obtain wireless services via a cellular wireless network. Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. A wireless device can include multiple SIMs and/or eSIMs to provide access to different cellular wireless service subscriptions. Newer generation cellular wireless networks, e.g., fifth generation (5G) new radio (NR) wireless networks are being deployed, and elements of the 5G NR wireless networks, in some arrangements can be shared between multiple MNOs. In some cases, a cell of a 5G NR wireless network can be associated with two different MNOs, and a wireless device that supports multiple SIMs and/or eSIMs can connect to the common cell using two (or more) distinct SIMs and/or eSIMs. The wireless device can maintain distinct software stacks to support communication via each of the SIMs and/or eSIMs. Monitoring system information (SI) for each SIM and/or eSIM connected to the same cell independently by each software stack can waste computing resources and delay availability of SI updates, particularly in a wireless device with limited wireless circuitry shared between the SIMs and/or eSIMs. There exists a need for efficient and timely monitoring and sharing of SI updates among multiple software stacks associated with different SIMs and/or eSIMs of a wireless device that supports multiple SIMs and/or eSIMs.

### SUMMARY

This application relates to wireless communications, including methods and apparatus for sharing system information (SI) updates on a wireless device that supports multiple subscriber identity modules (SIMs) and/or electronic SIMs (eSIMs), which can be referred to as a multi-SIM/eSIM wireless device. In some embodiments, two (or more) mobile network operators (MNOs) deploy fifth generation (5G) new radio (NR) cellular wireless networks that share a common radio access network (RAN) with separate core networks. The common 5G NR RAN allows wireless devices that use SIMs and/or eSIMs associated with different MNOs to access 5G NR capabilities for wireless devices, without requiring each MNO to deploy separate RANs. A gNodeB (gNB) of a cell of the common 5G NR RAN can broadcast public land mobile network (PLMN) identifiers for multiple MNOs from the same cell. Similarly, an MNO can share its 5G NR RAN to a roaming wireless device to improve 5G NR cell coverage for wireless devices from other MNOs. A multi-SIM/eSIM wireless device can include two distinct SIMs and/or eSIMs associated with two different subscriptions for access to 5G NR cellular wireless services of two different MNOs. The multi-SIM/eSIM wireless device can include common cellular wireless circuitry that allows for communicating with only one cellular wireless network at a time. When the gNB of the 5G NR wireless network provides access to 5G NR cellular wireless services for the two different MNOs, the multi-SIM/eSIM wireless device can camp on the cell of the 5G NR cellular wireless network independently using each of the two distinct SIMs and/or eSIMs. The multi-SIM/eSIM wireless device can determine that the two different SIMs/eSIMs are connected to the same cell based on information included in a system information broadcast type 1 (SIB1) message received from the cell of the 5G NR cellular wireless network. Both PLMN identifiers can be associated with a common globally unique cell identifier (ID) value, indicating that the same cell provides access for two different MNOs. The multi-SIM/eSIM wireless device can efficiently monitor and share SI information between different software stacks associated with each of the two SIMs/eSIMs used to camp on the common cell of the 5G NR cellular wireless network. Indications of changes to system information (SI) for the cell of the 5G NR cellular wireless network can be monitored by both of the SIMs/eSIMs, and in response to receipt of an SI change indication, one of the SIMs/eSIMs can monitor broadcast SI blocks (SIMs) and/or request from the 5G cellular wireless network SI messages that include updated SI values. The one SIM/eSIM can store the updated SI values in a shared memory and provide a notification to the second SIM/eSIM of the availability of the updated SI values. In some embodiments, when a first SIM/eSIM is in a radio resource control (RRC) idle state or in an RRC connected state with a data connection and a second SIM/eSIM is in an RRC idle state, a designated primary SIM/eSIM used for data connections, which can be the first SIM/eSIM or the second SIM/eSIM, can accumulate and share the updated SI values via the shared memory with the other SIM/eSIM, which can be referred to as a secondary SIM/eSIM. In some embodiments, when a first SIM/eSIM is in an RRC connected state with a voice connection, and the second SIM/eSIM is in an RRC idle state, the first SIM/eSIM can monitor for broadcast SIBs that include updated SI values during the voice connection if available. When one or more SI values are not broadcast by the cell of the 5G NR cellular wireless network, the first SIM/eSIM, after termination of the voice connection, can send a request to the cell of the 5G NR cellular wireless network to transmit on demand the updated SI values. The first SIM/eSIM can receive one or more messages from the 5G NR cellular wireless network with the updated SI values, store the updated SI values (received in broadcast SIBs and/or in on-demand messages) in a shared memory accessible to the second SIM/eSIM, and subsequently notify the second SIM/eSIM of the availability of the updated SI values.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement cellular service provisioning to a wireless device, according to some embodiments.

FIG. 2 illustrates a block diagram of a more detailed view of exemplary components of the system of FIG. 1, according to some embodiments.

FIG. 3A illustrates an example of a multiple subscriber identity module (SIM)/electronic SIM (eSIM) wireless device communicating with two wireless networks, in accordance with some embodiments.

FIG. 3B illustrates examples of wireless devices that support multiple subscriber identities, in accordance with some embodiments.

FIG. 4 illustrates a table summarizing examples of shared cellular wireless network architectures, according to some embodiments.

FIG. 5 illustrates a diagram of paging communication for two distinct SIMs/eSIMs of a multi-SIM/eSIM wireless device by a 5G NR cellular wireless network, according to some embodiments.

FIGS. 6A and 6B illustrate flowcharts of exemplary sets of actions performed by a multi-SIM/eSIM wireless device to update system information (SI) values for two distinct SIMs/eSIMs, according to some embodiments.

FIG. 7 illustrates a flowchart of an exemplary method performed by a multi-SIM/eSIM wireless device to update SI values for two distinct SIMs/eSIMs, according to some embodiments.

FIG. 8 illustrates a block diagram of exemplary elements of a 5G-capable mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus for sharing system information (SI) updates on a wireless device that supports multiple subscriber identity modules (SIMs) and/or electronic SIMs (eSIMs), which can be referred to as a multi-SIM/eSIM wireless device. Two (or more) mobile network operators (MNOs) can deploy fifth generation (5G) new radio (NR) cellular wireless networks that share a common radio access network (RAN) with separate core networks to allow for more rapid deployment and access to 5G NR cellular wireless services for different MNOs. For example, a first MNO can deploy and manage 5G NR cellular wireless RAN equipment in a particular geographic region and share the 5G NR RAN equipment with one or more additional MNOs, which may not have deployed their own 5G NR RAN equipment in the same geographic region. The common 5G NR RAN can allow different wireless devices that use SIMs and/or eSIMs associated with different MNOs to access 5G NR cellular wireless services for their respective MNOs, without requiring each MNO to deploy separate 5G NR RANs. A gNodeB (gNB) of a cell of the common 5G NR RAN can broadcast public land mobile network (PLMN) identifiers for multiple MNOs from the same cell with identical cell identifiers used. Each MNO can deploy and managed their own core networks that provide 5G cellular wireless services accessible via the common 5G NR RAN. Similarly, an MNO can share its 5G NR RAN to a roaming wireless device to improve 5G NR cell coverage for wireless devices from other MNOs.

While this shared deployment allows wireless devices that use SIMs/eSIMs from different MNOs to each have access to 5G cellular wireless services without requiring all of the MNOs to deploy their own local 5G NR RANs, sharing 5G NR access via a common 5G NR RAN can result in a single wireless device that supports multiple SIMs and/or eSIMs connecting to the same 5G NR RAN cell using different SIMs and/or eSIMs. The multi-SIM/eSIM wireless device can include two distinct SIMs and/or eSIMs associated with two different subscriptions for access to 5G NR cellular wireless services of two different MNOs. The multi-SIM/eSIM wireless device use two different SIMs/eSIMs to camp on the same cell of the common 5G NR RAN and register with two different MNOs for access to 5G cellular wireless services of the respective two different MNOs. In some embodiments, the multi-SIM/eSIM wireless device can include common cellular wireless circuitry that allows for communicating with only one cellular wireless network at a time. The use of two different SIMs/eSIMs with connections to only one cellular wireless network at a time can be referred to as a dual SIM dual standby (DSDS) capability. Each SIM/eSIM can be associated with its own software stack within the multi-SIM/eSIM wireless device, and the respective software stacks can independently manage communication with their respective 5G cellular wireless networks. Each software stack can monitor for paging messages for incoming connections to their respective 5G cellular wireless networks. In addition, each software stack can monitor for system information (SI). Because the multi-SIM/eSIM wireless device is connected to a common cell of a 5G NR RAN, SI values for the common cell can be identical for both software stacks. As such, monitoring the SI values independently by each software stack can be wasteful of computing resources of the multi-SIM/eSIM wireless device. In addition, when the multi-SIM/eSIM wireless device only supports DSDS capability, only one of the software stacks can communicate with the cell of the 5G NR RAN at one time, and certain monitoring mechanisms for updating the SI values by both software stacks in parallel could result in a race condition for access to the cell. As discussed herein, instead of having both software stacks for both SIMs/eSIMs acquire updated SI values independently, a software stack for one of the SIMs/eSIMs can receive the updated SI values and share the updated SI values with a software stack for another of the SIMs/eSIMs.

Indications of changes to system information (SI) for the cell of the 5G NR cellular wireless network can be monitored by both of the SIMs/eSIMs in parallel (i.e., by independent software stacks associated with each SIM/eSIM). Each of the SIMs/eSIMs can receive downlink control information (DCI) messages during their respective paging occasions of paging cycles. Multiple paging cycles can be grouped together to form a broadcast control channel (BCCH) modification period. A gNB of the 5G NR RAN can broadcast, via the common cell, an SI change indication included in DCI messages sent during a first BCCH modification period to alert the multi-SIM/eSIM wireless device that one or more SI values will change in a next BCCH modification period. The SI change indication can be a system information modification bit included in a short message field of a DCI format 1_0 message and set to a “1” value to inform the UE of the impending SI value changes. Each of the SIMs/eSIMs can receive the SI change indication; however, only one of the SIMs/eSIMs acquires the SI value changes. Depending on a state of connections between the multi-SIM/eSIM wireless device with the cell of the 5G NR cellular wireless network, either a first SIM/eSIM or a second SIM/eSIM will determine the SI value changes and provide the SI value changes to the other SIM/eSIM.

In response to receipt of the SI change indication, one of the SIMs/eSIMs, e.g., a first SIM/eSIM, receives a broadcast SIB 1 message during the BCCH modification period that immediately follows the first BCCH modification period. The SIB 1 message includes value tags for each of additional SI, and the SIM/eSIM compares the value tags for each of the additional SI in the SIB 1 message to a most recently previously received and stored value tags for each of the additional SI. When a new value tag for an SI differs from the previously stored value tag, the SIM/eSIM determines that the SI requires refreshing and will collect the updated SI values accordingly. The SIB 1 message also includes an SI status value for each SI that indicates whether the particular SI is broadcast by the cell of the 5G NR cellular wireless network at regular intervals or is set to “not broadcast” indicating that the multi-SIM/eSIM wireless device must request transmission of the particular SI (or of multiple SI) on demand by the 5G NR cellular wireless network.

For SI that are broadcast, the first SIM/eSIM of the multi-SIM/eSIM wireless device monitors for broadcast SI messages and extracts the updated SI values from the broadcast SI messages. For SI that are not broadcast, the first SIM/eSIM of the multi-SIM/eSIM wireless device sends one or more requests to the 5G cellular wireless network to transmit one or more SI messages that include updated SI values. The previously received SIB1 message can include a request configuration, a random-access configuration, and a preamble index. In some embodiments, the SIB1 message includes a single request configuration that can be used to receive all non-broadcast SI messages. In some embodiments, the SIB1 message includes multiple request configurations with distinct preamble indices for each of the non-broadcast SI messages. The multi-SIM/eSIM wireless device transmits an SI request for all or some of the non-broadcast SI messages by performing a random-access procedure using the random-access configuration and preamble index associated with the non-broadcast message(s). In some embodiments, the multi-SIM/eSIM wireless device sends a single SI request for all non-broadcast SI messages. In some embodiments, the multi-SIM/eSIM wireless device sends multiple SI requests to receive the non-broadcast SI messages.

Based on monitoring broadcast SI messages and/or responses to SI requests, the software stack of the first SIM/eSIM receives and stores the updated SI values in a shared memory. The software stack of the first SIM/eSIM then provides a notification to a software stack of a second SIM/eSIM indicating availability of the updated SI values. In some embodiments, when a first SIM/eSIM is in a radio resource control (RRC) idle state or in an RRC connected state with a data connection and a second SIM/eSIM is in an RRC idle state, a designated primary SIM/eSIM used for data connections, which can be the first SIM/eSIM or the second SIM/eSIM, can accumulate and share the updated SI values via the shared memory with the other SIM/eSIM, which can be referred to as a secondary SIM/eSIM. In some embodiments, when a first SIM/eSIM is in an RRC connected state with a voice connection, and the second SIM/eSIM is in an RRC idle state, the first SIM/eSIM can monitor for broadcast SIBs that include updated SI values during the voice connection if available. When one or more SI values are not broadcast by the cell of the 5G NR cellular wireless network, the first SIM/eSIM, after termination of the voice connection, can send one or more SI requests to the cell of the 5G NR cellular wireless network to transmit on demand the updated SI values. The first SIM/eSIM can receive one or more responses from the 5G NR cellular wireless network with the updated non-broadcast SI values. The first SIM/eSIM can store updated SI values (received previously in broadcast SIBs and/or in response to one or more SI request messages) in a shared memory accessible to the second SIM/eSIM, and subsequently notify the second SIM/eSIM of the availability of the updated SI values.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

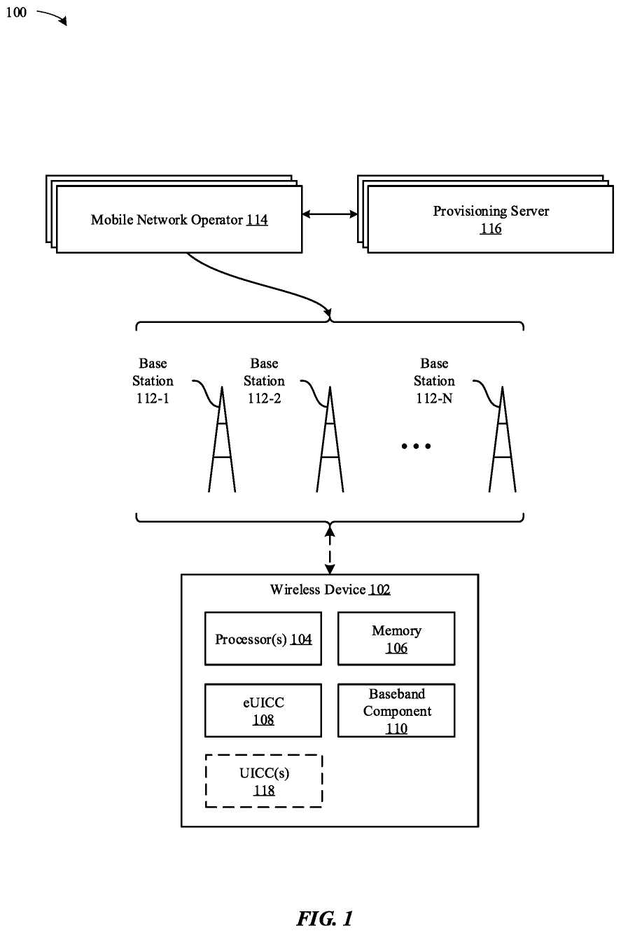

These and other embodiments are discussed below with reference to FIGS. 1 through 8; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a wireless communication device, a mobile device, a user equipment (UE), a device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., an iPhone® or an iPad® by Apple®). The base stations 112-1 to 112-N can represent cellular wireless network entities including fourth generation (4G) Long Term Evolution (LTE) evolved NodeBs (eNodeBs or eNBs) and/or fifth generation (5G) NodeBs (gNodeBs or gNBs) that are configured to communicate with the wireless device 102. The MNOs 114 can represent different wireless service providers that provide specific services (e.g., voice and data) to which a user of the wireless device 102 can subscribe to access the services via the wireless device 102. Applications resident on the wireless device 102 can advantageously access services using 4G LTE connections and/or 5G connections via the base stations 112. The wireless device 102 can include processing circuitry, which can include one or more processors 104 and a memory 106, an embedded Universal Integrated Circuit Card (eUICC) 108, and a baseband component 110. In some embodiments, the wireless device 102 includes one or more physical UICCs 118, also referred to as Subscriber Identity Module (SIM) cards, in addition to the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing services offered by one or more different MNOs 114 via communication through base stations 112-1 to 112-N. Similarly, one or more UICCs 118 can include universal SIMs (USIMs) for access to associated MNO 114 services. To be able to access services provided by the MNOs, one or more eSIMs can be provisioned to the eUICC 108 of the wireless device 102 (or one or more UICCs 118 installed in the wireless device 102).

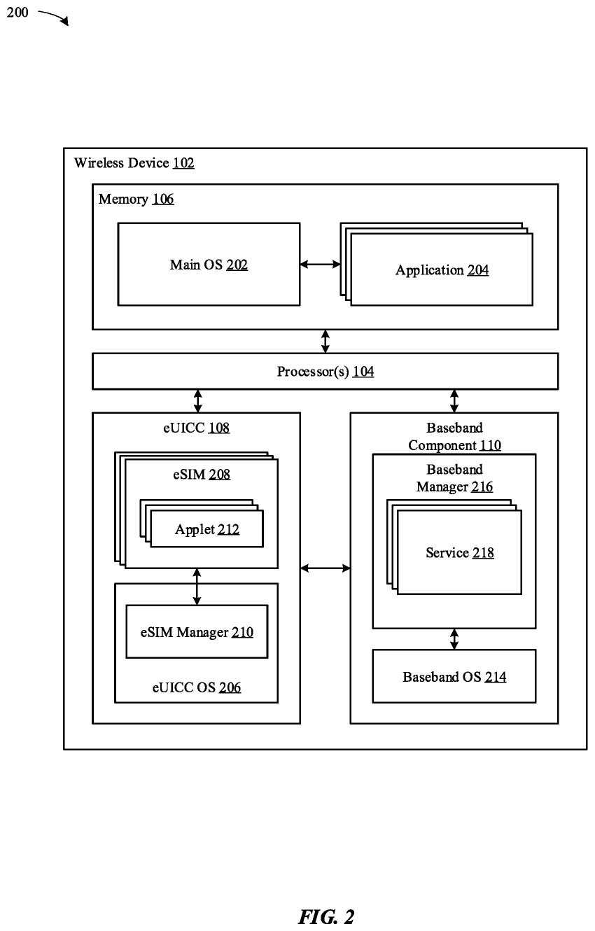

FIG. 2 illustrates a block diagram 200 of a more detailed view of the wireless device 102 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states. The wireless device 102 includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

A baseband component 110 of the wireless device 102 can include a baseband OS 214 that is configured to manage hardware resources of the baseband component 110 (e.g., a processor, a memory, different radio components, etc.). According to some embodiments, the baseband component 110 can implement a baseband manager 216 that is configured to interface with the eUICC 108 to establish a secure channel with a provisioning server 116 and obtaining information (such as eSIM data) from the provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

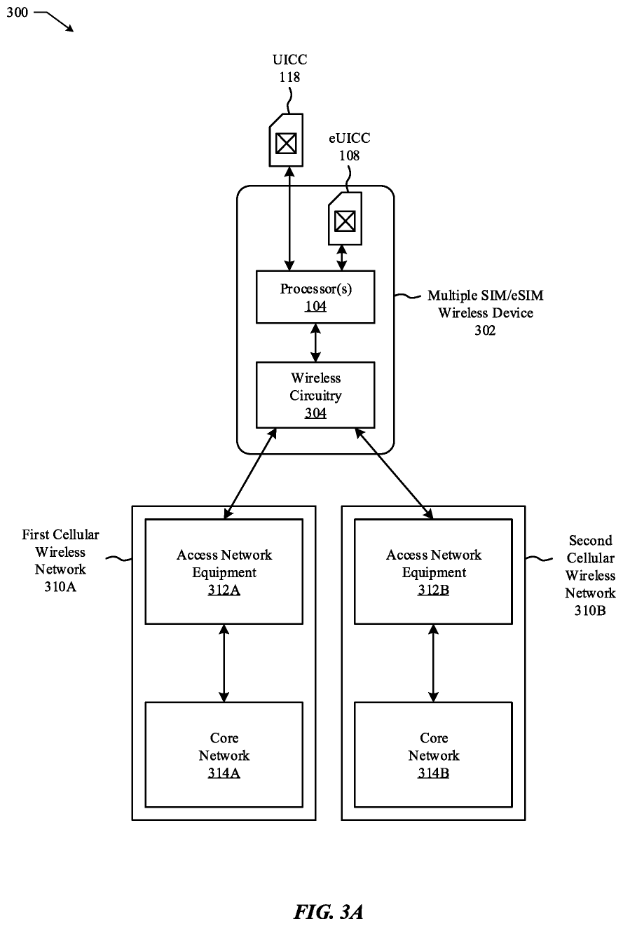

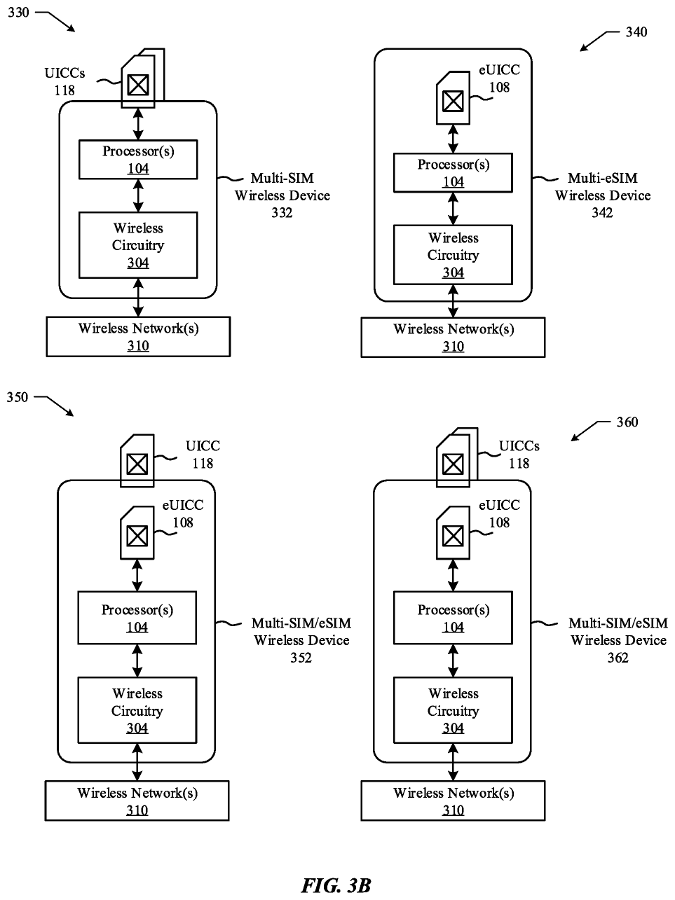

FIG. 3A illustrates a diagram 300 of a multi-SIM/eSIM wireless device 302, which can be a form of wireless device 102, including one or more processor(s) 104 and wireless circuitry 304 that provides for wireless radio frequency (RF) connections between the multi-SIM/eSIM wireless device 302 and a first cellular wireless network 310A and a second cellular wireless network 310B. In some embodiments, the wireless circuitry 304 includes one or more baseband processor(s), and a set of RF analog front-end circuitry. In some embodiments, the wireless circuitry 304 and/or a portion thereof can include or be referred to as a wireless transmitter/receiver or a transceiver or a radio. The terms circuit, circuitry, component, and component block may be used interchangeably herein, in some embodiments, to refer to one or more operational units of a wireless device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 304 can include components of RF analog front-end circuitry, e.g. a set of one or more antennas, which can be interconnected with additional supporting RF circuitry that can include filters and other analog components that can be “configured” for transmission and/or reception of analog signals via one or more corresponding antennas to one of the first and second cellular wireless networks 310A/B.

The multi-SIM/eSIM wireless device 302 can include hardware restrictions that limit the multi-SIM/eSIM wireless device 302 to connect to only one of the first and second cellular wireless networks 310A/310B via their respective access network equipment 312A/312B at a time. For example, the wireless circuitry 304 can include a single transmitter and one or more receivers used for cellular wireless communication, so that only one active bi-directional cellular radio frequency connection to a cellular access network can be used at a time. When the multi-SIM/eSIM wireless device 302 has an active connection via the access network equipment 312A of the first cellular wireless network 310A, the multi-SIM/eSIM wireless device 302 can be precluded from establishing another active connection via the access network equipment 312B of the second cellular wireless network 310B (or from establishing a second active connection to the first cellular wireless network 310A). In some embodiments, the multi-SIM/eSIM wireless device 302 can be registered with multiple subscriptions that correspond to different SIMs/eSIMs at the same time.

The multi-SIM/eSIM wireless device 302 can register with multiple wireless networks, e.g., the first and second cellular wireless networks 310A/B, simultaneously. The wireless circuitry 304 of the multi-SIM/eSIM wireless device 302 can be configured to register with and/or establish a connection with the first cellular wireless network 310A via access network equipment 312A, which interfaces with a core network 314A. The wireless circuitry 304 of the multi-SIM/eSIM wireless device 302 can also be configured to register with and/or establish a connection with the second cellular wireless network 310B via access network equipment 312B, which interfaces with a core network 314B. The wireless circuitry 304 of the multi-SIM/eSIM wireless device 302 can support transmission and reception to only one of the first and second wireless networks 310A/B, via their respective access networks 312A/B at a time. As the multi-SIM/eSIM wireless device 302 can register with two different wireless networks simultaneously via two different subscriptions, the multi-SIM/eSIM wireless device 302 can appear as two distinct devices (each associated with a different number, user, and/or subscription). A multi-SIM/eSIM wireless device 302 that can connect to only one wireless network at a time but can monitor and/or receive communication from multiple wireless networks with which it is registered can be referred to as a Multiple SIM, Multiple Standby (MSMS) wireless device (or in the case of wireless device with two SIMs/eSIMs as a dual-SIM, dual-Standby (DSDS) wireless device). In a 5G NR cellular wireless network that includes shared access network equipment with separate core networks, the multi-SIM/eSIM wireless device 302 can be connected to the same access network equipment for access to services of two different cellular wireless networks. While the multi-SIM/eSIM wireless device 302 of FIG. 3A includes a UICC 118 and an eUICC 108, other configurations for multi-SIM/eSIM wireless devices 302 are possible.

FIG. 3B illustrates diagrams of exemplary multi-SIM/eSIM wireless devices that support multiple subscriber identities using removable UICCs 118 with SIMs and/or eUICCs 108 with eSIMs 208 implemented thereon. As illustrated in diagram 330, a multi-SIM wireless device 332 includes multiple UICCs 118, which can be inserted and removed individually or together, and communicate with one or more processors 104 that connect to wireless circuitry 304 that provides for wireless communication with one or more wireless networks 310. As the physical size and design of the multi-SIM wireless device 332 can limit the number of UICCs 118 that can be supported, alternatively, as illustrated in diagram 340, a multi-eSIM wireless device 342 can include an eUICC 108 connected with the processor(s) 104 and to the wireless network(s) 310 via the wireless circuitry 304. The eUICC 108 can store multiple eSIMs 208, each eSIM 208 can be associated with a distinct subscriber identity and/or provide distinct services or subscriptions for a user of the multi-eSIM wireless device 342. Diagram 350 illustrates an exemplary multi-SIM/eSIM wireless device 352 that includes a removable UICC 118, on which can be installed one or more SIMs, and an eUICC 108 on which one or more eSIMs 208 can be installed. The multi-SIM/eSIM wireless device 352 can represent another form of the wireless device 102 of FIG. 1. Diagram 360 illustrates another multi-SIM/eSIM wireless device 362 that includes multiple UICCs 118, on which one or more SIMs can be installed, and an eUICC 108, on which one or more eSIMs 208 can be installed. The combination of SIMs on the UICCs 118 and/or eSIMs 208 on the eUICC 108 can provide for connections to one or more wireless networks 310 using the wireless circuitry 304 under the control of the processor(s) 104 of the multi-SIM/eSIM wireless device 362.

In general, a multi-SIM/eSIM wireless device that supports multiple subscriber identities can include (i) at least one UICC 118 that supports multiple SIMs, (ii) an eUICC 108 that supports multiple eSIMs 208, or (iii) a combination of a UICC 118 and an eUICC 108. Each UICC 118 can support one or more SIMs, and each eUICC 108 can support one or more eSIMs 208. A multi-SIM/eSIM wireless device that supports multiple subscriber identities, e.g., 102, 332, 342, 352, 362, can include a combination of SIMs and/or eSIMs 208 to support communication with one or more wireless networks 310.

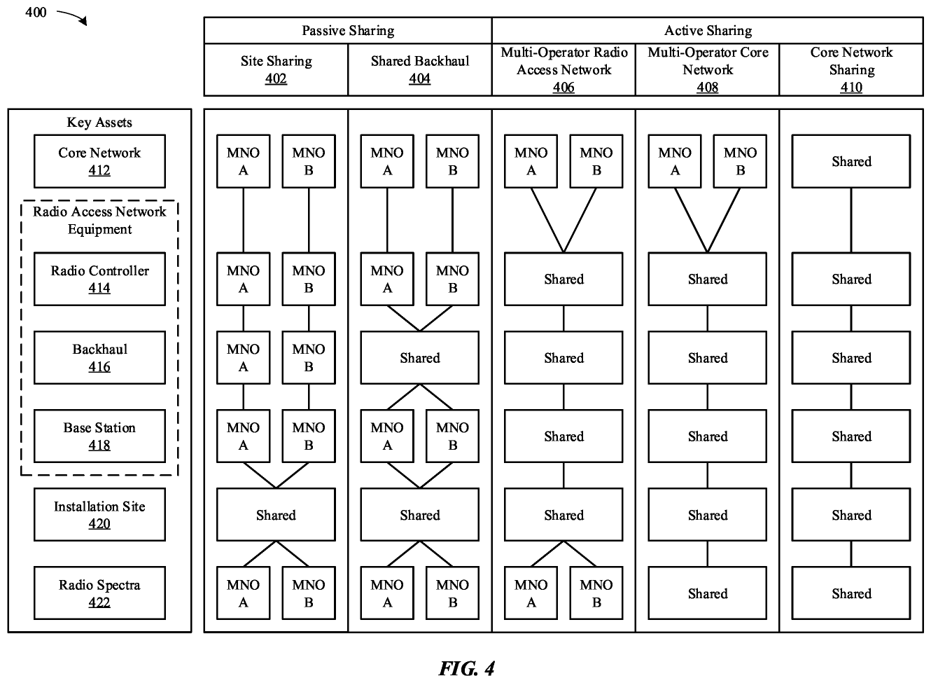

FIG. 4 illustrates a table 400 summarizing several different configurations for sharing cellular wireless network equipment between two different MNOs 114. The MNOs 114 can share key assets of a cellular wireless network in order to provide access to newer technology, such as to 5G cellular baseband resources deployed and managed by a first MNO 114, e.g., MNO A, to subscribers associated with a second MNO 114, e.g., MNO B. Given substantial cost to deploy new cellular radio technologies, MNOs A and B can agree to an arrangement in which a 5G-capable wireless device, e.g., a wireless device 102, that includes a UICC (SIM card) 118 or an eSIM 208 of MNO B can access 5G cellular baseband resources deployed by MNO A. Different architectures have been proposed for sharing one or more key assets of cellular wireless networks as illustrated in FIG. 4. Passive sharing arrangements provide for minimal infrastructure shared between MNOs 114, while active sharing arrangements enable cellular network equipment of various types to be shared between MNOs 114. In a site sharing arrangement 402, two different MNOs 114, e.g., MNO A and MNO B, can maintain distinct cellular wireless equipment both at the core network 412 level and at the local radio access network (RAN) equipment level, with only one or more installation sites 420 to be shared between the MNOs 114. Each of the MNOs 114 can also use different radio frequency bands, indicated as radio spectra 422 in FIG. 4. In a shared backhaul arrangement 404, the MNOs 114 can additionally share backhaul connections 416 between their own radio controllers 414 and base stations 418. In a multi-operator radio access network sharing arrangement 406, two different MNOs 114, e.g., MNO A and MNO B, can further share radio access network equipment, e.g., radio controllers 414, backhaul connections 416, and base stations 418, while maintaining separate radio spectra 422. In a multi-operator core network arrangement 408, the two different MNOs 114 can further share a common radio spectrum 422. Finally, in a core network sharing arrangement 410, the two distinct MNOs 114 can share core network 412 equipment. The techniques described herein focus on arrangements where two different MNOs 114 allow sharing of RAN equipment, so that wireless devices 102 of a second MNO 114, e.g., MNO B, can gain access to 5G cellular baseband resources of a first MNO 114, e.g., MNO A.

In some embodiments, the multi-operator core network 408 allows a wireless device 102 that supports multiple SIMs/eSIMs to connect to MNO A 114 and MNO B 114 using different SIMs/eSIMs through a common shared cell. System information (SI) broadcast (and/or available on demand) from the cell can be shared between SIMs/eSIMs, as software stacks for each SIM/eSIM can be connected to the identical cell of the 5G cellular wireless network. A SI block (SIB) Type 1 (SIB1) message broadcast by a cell of the 5G cellular wireless network, e.g., which can be a multi-operator core network 408 that shares RAN equipment and cells while maintaining separate core network equipment, includes a cell access related information field that includes distinct PLMN identifiers for each of the MNOs, e.g., MNO A 114 and MNO B 114, and additional information, e.g., a tracking area code (TAC) value and a globally unique cell identity value. When shared between two different MNOs 114, the globally unique cell identity value associated with each MNO 114 will be identical. A wireless device 102 can determine whether a first cell associated with a first MNO 114 to which a first SIM or eSIM 208 of the wireless device 102 is connected or camped on and a second cell associated with a second MNO 114 to which the first SIM or eSIM 208 of the wireless device 102 is also connected are the identical cell by comparing the cell identity values provided in the broadcast SIB1 message for each of the PLMN identifier values that specify the MNOs 114. In geographic areas where a cell of a RAN of a first MNO 114, e.g., MNO B 114, is unavailable, such as due to limited coverage of radio frequencies used by the first MNO 114 for 5G NR cellular wireless services, the wireless device 102 can connect to a cell of a RAN of the second MNO 114, e.g., MNO A 114, which may be using radio frequencies that have a broader geographic coverage. The cell of the second MNO 114 broadcasts the PLMN identifiers in SIB1 messages for both MNO A 114 and MNO B 114 distinct PLMN identifiers for each MNO 114 but a common cell identity value.

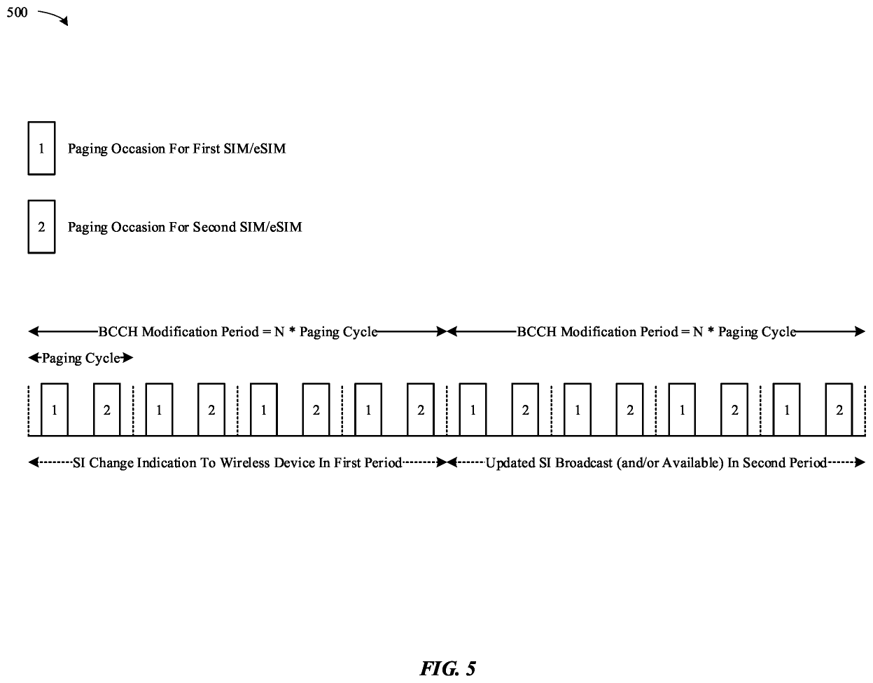

FIG. 5 illustrates a diagram 500 of paging communication for two distinct SIMs/eSIMs of a multi-SIM/eSIM wireless device by a 5G NR cellular wireless network. A SIB1 message broadcast by the 5G NR cellular wireless network includes parameters that specify properties of a paging control channel (PCCH) and a broadcast control channel (BCCH). A gNB of a cell of a 5G NR cellular wireless network establishes unique paging occasions for each wireless device 102 camped on the cell, each paging occasion occurring at a different position within a paging cycle. Consecutive paging cycles repeat the paging occasions for the wireless devices 102, and multiple paging cycles are grouped together to form a BCCH modification period. A wireless device 102 decodes a downline control information (DCI) message having a DCI format 1_0 and scrambled with a paging radio network temporary identifier (P-RNTI) used by the wireless device 102 for paging reception. The wireless device 102 checks a short message field in the DCI message to determine whether a system information (SI) modification bit is set to a particular value, e.g., a “1” value, indicating that values for one or more SI will change in a subsequent time period. In particular, the wireless device 102 reads the DCI message during a first BCCH modification period to learn whether the SI change in a subsequent BCCH modification period that immediately follows the first BCCH modification period. When the SI modification bit indicates that there are one or more SI updated values, the wireless device 102 receives and decodes a SIB1 message broadcast by the 5G NR cellular wireless network during the subsequent BCCH modification period. The wireless device 102 extracts value tags for additional SI inside the SIB1 message and compares the extracted value tags for the additional SI to stored value tags previously most recently received and stored for the additional SI. When a value tag for an SI of the additional SI extracted from the SIB1 message differs from a previously stored value tag for the SI, the wireless device 102 determines the SI requires to be refreshed. The wireless device 102 checks the value tags for all of the additional SI in the SIB1 message to determine which of the additional SI require updating and subsequently collects updated values for the additional SI.

The 5G NR cellular wireless network includes in the SIB1 message information to specify mapping of SIBs to SI messages, an indication for each SI message whether the SI message is broadcast by the 5G NR cellular wireless network or not broadcast, and a periodicity for each broadcast SI message (each SI message can have its own periodicity). The wireless device 102 can receive updated SI values (for those SI that require updating) by receiving broadcast SI messages from the 5G NR cellular wireless network or by requesting that the 5G NR cellular wireless network transmit the updated SI values for non-broadcast SI messages. When at least one of the additional SI are not broadcast by the 5G NR cellular wireless network, the SIB1 message information can also include an SI request configuration to specify how the wireless device 102 can transmit a message as part of a random access channel (RACH) procedure to trigger the 5G NR cellular wireless network to transmit the non-broadcast SI messages to the wireless device 102. In some embodiments, the SI request configuration includes a random access configuration and preamble index for the wireless device 102 to use to send the SI request message to the 5G NR cellular wireless network. In some embodiments, a single SI request message is used for the wireless device 102 to request transmission of all non-broadcast SI messages. In some embodiments, a separate SI request configuration is used for each non-broadcast SI message, and the wireless device 102 transmits individual SI request messages for each non-broadcast SI message to be transmitted individually to the wireless device 102.

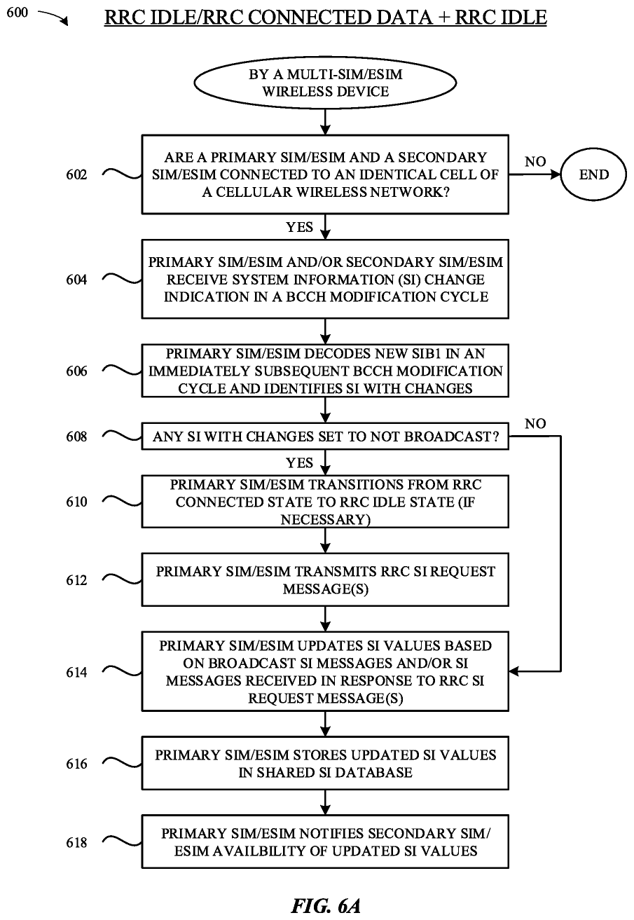

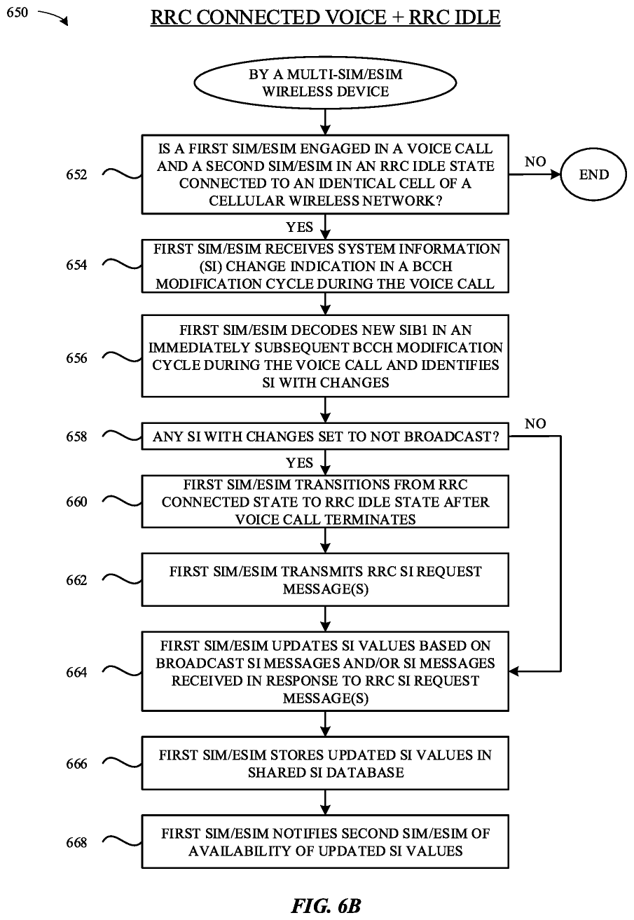

FIG. 6A illustrates a flowchart 600 of an exemplary set of actions performed by a multi-SIM/eSIM wireless device to update system information (SI) values for two distinct SIMs/eSIMs included in the multi-SIM/eSIM wireless device, where the multi-SIM/eSIM wireless device is connected via the two SIMs/eSIMs with both in an RRC idle state or with one SIM/eSIM in an RRC idle state and the other SIM/eSIM in an RRC connected state for a data connection. The two distinct SIMs/eSIMs can be each associated with a different MNO 114 and provide access to different 5G NR cellular wireless networks that share radio access network (RAN) equipment with a common cell to which the multi-SIM/eSIM wireless device can connect or camp on using both the of SIMs/eSIMs at the same time. In some embodiments, the multi-SIM/eSIM wireless device includes one or more SIMs/eSIMs in addition to the two distinct SIMs/eSIMs that can be used with the cell that is common to the two different 5G NR cellular wireless networks. The multi-SIM/eSIM wireless device, at 602, can determine whether a primary SIM/eSIM, designated for data use by the multi-SIM/eSIM wireless device, and a secondary SIM/eSIM are both connected to (or camped on) an identical cell of a 5G NR cellular wireless network. In some embodiments, the multi-SIM/eSIM wireless device uses cell access related information included in a SIB1 message to determine whether the primary SIM/eSIM and the secondary SIM/eSIM are connected to (or camped on) the same cell of the 5G NR cellular wireless network. The cell access related information in the SIB1 message can include distinct PLMN identifiers for the two different 5G NR cellular wireless networks both having identical globally unique cell identifier values.

When connected to (or camped on) an identical cell with both the primary SIM/eSIM and the secondary SIM/eSIM, the multi-SIM/eSIM wireless device, at 604, receives, during respective paging occasions of the primary SIM/eSIM and/or the secondary SIM/eSIM, an SI change indication in a downlink control information (DCI) message during a first BCCH modification cycle that includes multiple paging cycles of paging occasions. The multi-SIM/eSIM wireless device can receive the SI change indication via the primary SIM/eSIM or the secondary SIM/eSIM first, as their respective paging occasions can precede or follow each other. It should be noted that each SIM/eSIM that is enabled on the multi-SIM/eSIM wireless device and connected to or camped on a cell of a cellular wireless network can have an associated software stack that processes and manages communication associated with the SIM/eSIM. In some instances, we refer to a SIM/eSIM performing various actions, however, in an actual implementation a software stack associated with the SIM/eSIM (or a processor that executes the software stack) performs the actions described. The SI change indication informs the multi-SIM/eSIM wireless device that values for one or more SI will change (from those currently used) in the next BCCH modification cycle. The multi-SIM/eSIM wireless device can use a software stack of the primary SIM/eSIM to obtain updated SI values and subsequently share the updated SI values with a separate software stack associated with the secondary SIM/eSIM, when neither the primary SIM/eSIM nor the secondary SIM/eSIM are connected to the cell of the 5G NR cellular wireless network for an active voice connection. Both the primary SIM/eSIM and the secondary SIM/eSIM can be in an RRC idle state (or RRC inactive state), or one of the primary SIM/eSIM and the secondary SIM/eSIM can be in an RRC connected state for an active data connection, while the other of the primary SIM/eSIM can be in an RRC idle state. In some embodiments, the multi-SIM/eSIM wireless device can support only one active connection to the 5G NR cellular wireless network at a time.

At 606, the multi-SIM/eSIM wireless device receives, via the primary SIM/eSIM, and decodes a new SIBI message during a subsequent BCCH modification cycle that immediately follows the first BCCH modification cycle. At 606, the multi-SIM/eSIM wireless device uses information in the new SIBI message to identify which SI values require updating. At 608, the multi-SIM/eSIM wireless device further uses information in the new SIBI message to determine whether one or more SI values that require updating are broadcast by the 5G NR cellular wireless network periodically or are not broadcast by the 5G NR cellular wireless network and are sent only on demand. The information can specify a mapping of SI blocks (SIBs) to SI message and indicate periodicity of transmission of broadcast SI values. The information can also specify an SI request configuration for the multi-SIM/eSIM wireless device to use for sending an SI request to obtain one or more of the non-broadcast SI values. When at least one of the one or more SI values that require updating are not broadcast by the 5G NR cellular wireless network, the multi-SIM/eSIM wireless device, at 610, causes the primary SIM/eSIM to transition from the RRC connected state to an RRC idle state if connected to the 5G NR cellular wireless network by a data connection using the primary SIM/eSIM. At 612, the multi-SIM/eSIM wireless device transmits via the primary SIM/eSIM one or more RRC SI request messages to cause the 5G NR cellular wireless network to transmit SI messages that include the updated SI values for at least those SI values that require updating and are not broadcast periodically. The one or more RRC SI request messages can be sent as part of a random access channel (RACH) procedure. In some embodiments, the multi-SIM/eSIM wireless device transmits a single RRC SI request message and receives multiple updated SI values. In some embodiments, the multi-SIM/eSIM wireless device transmits multiple RRC SI request messages, e.g., one RRC SI request message for each non-broadcast SI value that requires updating. At 614, the multi-SIM/eSIM wireless device receives, from the 5G NR cellular wireless network via the primary SIM/eSIM, updated SI values in one or more broadcast messages and/or in response to one or more RRC SI request messages. At 616, the multi-SIM/eSIM wireless device stores the updated SI values in a shared memory (or database) accessible to both the primary SIM/eSIM and the secondary SIM/eSIM. At 618, the multi-SIM/eSIM wireless device provides a notification to the secondary SIM/eSIM (or its associated software stack) of the availability of the updated SI values. The software stack of the secondary SIM/eSIM can use the updated SI values for communication with the cell of the 5G NR cellular wireless network and not be required to obtain the updated SI values independently from the cell of the 5G NR cellular wireless network. In some embodiments, when at least one SI value that requires updating is not broadcast, the multi-SIM/eSIM wireless device obtains updated SI values including both broadcast and non-broadcast SI values, via one or more RRC SI request messages. In some embodiments, when at least one SI value that requires updating is broadcast, the multi-SIM/eSIM wireless device obtains the at least one SI value via receipt of a broadcast SIB. In some embodiments, the multi-SIM/eSIM wireless device obtains updated broadcast SI values via broadcast SIB and non-broadcast SI values via on-demand messages transmitted in response to one or more RRC SI request messages.

FIG. 6B illustrates a flowchart 650 of an exemplary set of actions performed by a multi-SIM/eSIM wireless device to update system information (SI) values for two distinct SIMs/eSIMs included in the multi-SIM/eSIM wireless device, where the multi-SIM/eSIM wireless device is connected via the two SIMs/eSIMs with one SIM/eSIM in an RRC idle state and the other SIM/eSIM in an RRC connected state for a voice connection. The two distinct SIMs/eSIMs can be each associated with a different MNO 114 and provide access to different 5G NR cellular wireless networks that share radio access network (RAN) equipment with a common cell to which the multi-SIM/eSIM wireless device can connect or camp on using both the of SIMs/eSIMs at the same time. In some embodiments, the multi-SIM/eSIM wireless device includes one or more SIMs/eSIMs in addition to the two distinct SIMs/eSIMs that can be used with the cell that is common to the two different 5G NR cellular wireless networks. The multi-SIM/eSIM wireless device, at 652, can determine whether a first SIM/eSIM being used for a voice connection and a second SIM/eSIM in an RRC idle state are both connected to (or camped on) an identical cell of a 5G NR cellular wireless network. In some embodiments, the multi-SIM/eSIM wireless device uses cell access related information included in a SIBI message to determine whether the first SIM/eSIM and the second SIM/eSIM are connected to (or camped on) the same cell of the 5G NR cellular wireless network. The cell access related information in the SIB1 message can include distinct PLMN identifiers for the two different 5G NR cellular wireless networks both having identical globally unique cell identifier values.

When connected to (or camped on) an identical cell with both the first SIM/eSIM (used for a voice connection) and the second SIM/eSIM (in an RRC idle state), the multi-SIM/eSIM wireless device, at 654, receives, via the voice connection of the primary SIM/eSIM, an SI change indication in a downlink control information (DCI) message during a first BCCH modification cycle. The multi-SIM/eSIM wireless device can receive the SI change indication via the primary SIM/eSIM or the secondary SIM/eSIM first, as their respective paging occasions can precede or follow each other. As described previously, each SIM/eSIM that is enabled on the multi-SIM/eSIM wireless device and connected to or camped on a cell of a cellular wireless network can have an associated software stack that processes and manages communication associated with the SIM/eSIM. In some instances, we refer to a SIM/eSIM performing various actions, however, in an actual implementation a software stack associated with the SIM/eSIM (or a processor that executes the software stack) performs the actions described. The SI change indication informs the multi-SIM/eSIM wireless device that values for one or more SI will change (from those currently used) in the next BCCH modification cycle. The multi-SIM/eSIM wireless device can use a software stack of the first SIM/eSIM to obtain updated SI values during the voice connection (when some updated SI values are broadcast) and/or after termination of the voice connection (when some updated SI values are not broadcast) and subsequently share the updated SI values with a separate software stack associated with the second SIM/eSIM.

At 656, the multi-SIM/eSIM wireless device, via the first SIM/eSIM used for the active voice connection, receives and decodes a new SIB1 message during a subsequent BCCH modification cycle that immediately follows the first BCCH modification cycle. At 656, the multi-SIM/eSIM wireless device uses information in the new SIB1 message to identify which SI values require updating. At 658, the multi-SIM/eSIM wireless device further uses information in the new SIB1 message to determine whether one or more SI values that require updating are broadcast by the 5G NR cellular wireless network periodically or are not broadcast by the 5G NR cellular wireless network and are sent only on demand. The information can specify a mapping of SI blocks (SIBs) to SI message and indicate periodicity of transmission of broadcast SI values. The information can also specify an SI request configuration for the multi-SIM/eSIM wireless device to use for sending an SI request to obtain one or more of the non-broadcast SI values. When at least one of the one or more SI values that require updating are not broadcast by the 5G NR cellular wireless network, the multi-SIM/eSIM wireless device, at 660, waits for the first SIM/eSIM to transition from the RRC connected state to an RRC idle state after the voice connection terminates. At 662, the multi-SIM/eSIM wireless device transmits, via the first SIM/eSIM, one or more RRC SI request messages to cause the 5G NR cellular wireless network to transmit SI messages that include the updated SI values for at least those SI values that require updating and are not broadcast periodically. The one or more RRC SI request messages can be sent as part of a random access channel (RACH) procedure. In some embodiments, the multi-SIM/eSIM wireless device transmits a single RRC SI request message and receives multiple updated SI values. In some embodiments, the multi-SIM/eSIM wireless device transmits multiple RRC SI request messages, e.g., one RRC SI request message for each non-broadcast SI value that requires updating. At 664, the multi-SIM/eSIM wireless device receives, from the 5G NR cellular wireless network via the first SIM/eSIM, updated SI values in one or more broadcast messages and/or in response to one or more RRC SI request messages. At 666, the multi-SIM/eSIM wireless device stores the updated SI values in a shared memory (or database) accessible to both the first SIM/eSIM and the second SIM/eSIM. At 668, the multi-SIM/eSIM wireless device provides a notification to the second SIM/eSIM (or its associated software stack) of the availability of the updated SI values. The software stack of the second SIM/eSIM can use the updated SI values for communication with the cell of the 5G NR cellular wireless network and not be required to obtain the updated SI values independently from the cell of the 5G NR cellular wireless network. In some embodiments, when at least one SI value that requires updating is not broadcast, the multi-SIM/eSIM wireless device obtains updated SI values including both broadcast and non-broadcast SI values, via one or more RRC SI request messages. In some embodiments, when at least one SI value that requires updating is broadcast, the multi-SIM/eSIM wireless device obtains the at least one SI value via receipt of a broadcast SIB. In some embodiments, the multi-SIM/eSIM wireless device obtains updated broadcast SI values via broadcast SIB and non-broadcast SI values via on-demand messages transmitted in response to one or more RRC SI request messages.

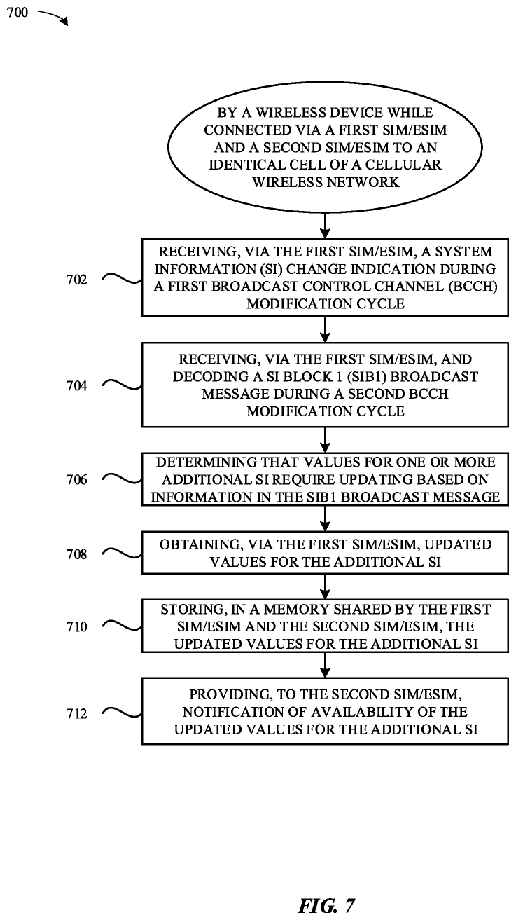

FIG. 7 illustrates a flowchart 700 of an exemplary method performed by a wireless device 102 to update SI values while connected to an identical cell of a cellular wireless network via a first SIM/eSIM and via a second SIM/eSIM. At 702, the wireless device 102 receives a system information (SI) change indication during a first broadcast control channel (BCCH) modification cycle. At 704, the wireless device 102 receives, via the first SIM/eSIM a SI block type 1 (SIB1 ) broadcast message during a second BCCH medication cycle. At 706, the wireless device 102 determines that values for one or more additional SI (i.e., other than SIB1 broadcast message) require updating based on information included in the SIBI broadcast message. At 708, the wireless device 102 obtains, via the first SIM/eSIM, updated values for the additional SI. At 710, the wireless device 102 stores, in a memory shared by the first SIM/eSIM and the second SIM/eSIM, the updated values for the additional SI. At 712, the wireless device 102 provides, to the second SIM/eSIM, notification of availability of the updated values for the additional SI in the shared memory.

In some embodiments, when the wireless device 102 is not connected to the 5G NR cell of the cellular wireless network via the first SIM/eSIM or the second eSIM/eSIM using a voice connection, the first SIM/eSIM used for acquiring the updated SI values is a primary SIM/eSIM designated for data usage, e.g., by default or based on user input. The wireless device 102 may be connected to the 5G NR cell of the cellular wireless network via the first (primary) SIM/eSIM via a data connection when receiving the SI change indication. In some embodiments, when the wireless device 102 is connected to the 5G NR cell of the cellular wireless network via a voice connection using the first SIM/eSIM when the SI change indication is received, and in this case the SIB1 broadcast message is received during the voice connection. In some embodiments, the wireless device 102 determines that values of the additional SI require updating by at least i) comparing value tags for the additional SI included in the SIB1 broadcast message to previously received and stored value tags for the additional SI, and ii) determining an SI requires updating when a value tag for the SI in the SIB1 broadcast message differs from a previously received and stored corresponding value tag for the SI. In some embodiments, the method performed by the wireless device 102 further includes the wireless device 102: i) determining updated values for one or more of the additional SI are broadcast by the 5G NR cell of the cellular wireless network, and ii) obtaining the updated values for the one or more of the additional SI from one or more broadcast messages from the 5G NR cell of the cellular wireless network during the second BCCH modification cycle. In some embodiments, the wireless device 102 obtains the updated values for at least one of the one or more of the additional SI during a voice connection using the first SIM/eSIM. In some embodiments, the method performed by the wireless device 102 further includes the wireless device 102: i) determining updated values for one or more of the additional SI are not broadcast by the 5G NR cell of the cellular wireless network, and ii) obtaining the updated values for the one or more of the additional SI in response to one or more radio resource control (RRC) SI request messages sent to the 5G NR cell of the cellular wireless network. In some embodiments, the wireless device 102 sends the one or more RRC SI request messages as part of a random access channel (RACH) procedure while the first SIM/eSIM is in an RRC idle state or RRC inactive state. In some embodiments, the wireless device 102 transitions the first SIM/eSIM from a radio resource control (RRC) connected state for a data connection to an RRC idle state or RRC inactive state prior to obtaining the updated values for the one or more additional SI. In some embodiments, the wireless device 102 transitions the first SIM/eSIM from a radio resource control (RRC) connected state for a voice connection to an RRC idle state or RRC inactive state prior to obtaining the updated values for the one or more additional SI. In some embodiments, the wireless device 102 obtains one or more of the updated values for the additional SI via broadcast messages received from the 5G NR cell of the cellular wireless network and obtains one or more of the updated values for the additional SI responsive to radio resource control (RRC) SI request messages send to the 5G NR cell of the cellular wireless network.

### Representative Exemplary Apparatus

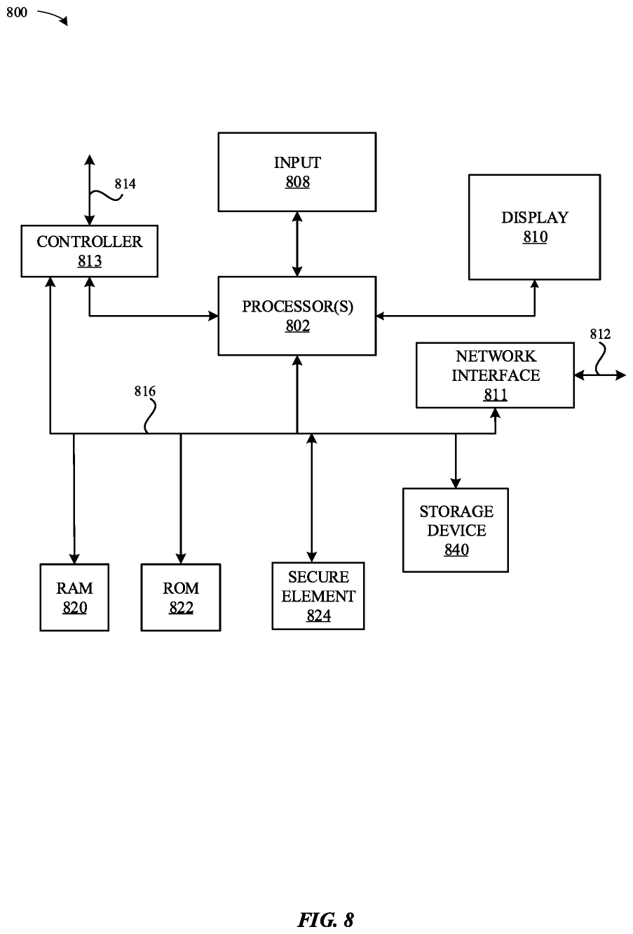

FIG. 8 illustrates in block diagram format an exemplary computing device 800 that can be used to implement the various components and techniques described herein, according to some embodiments. In particular, the detailed view of the exemplary computing device 800 illustrates various components that can be included in the wireless device 102. As shown in FIG. 8, the computing device 800 can include one or more processors 802 that represent microprocessors or controllers for controlling the overall operation of computing device 800. In some embodiments, the computing device 800 can also include a user input device 808 that allows a user of the computing device 800 to interact with the computing device 800. For example, in some embodiments, the user input device 808 can take a variety of forms, such as a button, keypad, dial, touch screen, audio input interface, visual/image capture input interface, input in the form of sensor data, etc. In some embodiments, the computing device 800 can include a display 810 (screen display) that can be controlled by the processor(s) 802 to display information to the user (for example, information relating to incoming, outgoing, or active communication sessions). A data bus 816 can facilitate data transfer between at least a storage device 840, the processor(s) 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include wireless circuitry, such as a wireless transceiver and/or baseband processor. The computing device 800 can also include a secure element 824. The secure element 824 can include an eUICC 108.

The computing device 800 also includes a storage device 840, which can include a single storage or a plurality of storages (e.g., hard drives), and includes a storage management module that manages one or more partitions within the storage device 840. In some embodiments, storage device 840 can include flash memory, semiconductor (solid state) memory or the like. The computing device 800 can also include a Random-Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of the computing device 800.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for sharing system information (SI) updates for a wireless device, the method comprising:
while the wireless device is connected to or camped on a fifth generation (5G) new radio (NR) cell of a cellular wireless network via a first subscriber identity module (SIM) or electronic SIM (eSIM) and via a second SIM or eSIM:
receiving, via the first SIM or eSIM, an SI change indication during a first broadcast control channel (BCCH) modification cycle;
receiving, via the first SIM or eSIM, and decoding an SI block (SIB) type one (SIB1) broadcast message during a second BCCH modification cycle;
determining additional SI require updating based on information included in the SIB1 broadcast message;
obtaining, via the first SIM or eSIM, updated values for the additional SI;
storing, in a memory shared by the first SIM or eSIM and the second SIM or eSIM, the updated values for the additional SI; and
providing, to the second SIM or eSIM, an indication of availability of the updated values for the additional SI.

2. The method of claim 1, wherein the first SIM or eSIM is a primary SIM or eSIM designated for data usage, when neither the first SIM or eSIM nor the second SIM or eSIM are connected to the 5G NR cell of the cellular wireless network via a voice connection.

3. The method of claim 1, wherein the wireless device is connected to the 5G NR cell of the cellular wireless network via a voice connection using the first SIM or eSIM when the SI change indication is received.

4. The method of claim 1, wherein determining the additional SI require updating comprises:
comparing value tags for the additional SI included in the SIBI broadcast message to previously received and stored value tags for the additional SI; and
determining an SI requires updating when a value tag for the SI in the SIB1 broadcast message differs from a previously received and stored corresponding value tag for the SI.

5. The method of claim 1, further comprising:
determining updated values for one or more of the additional SI are broadcast by the 5G NR cell of the cellular wireless network; and
obtaining the updated values for the one or more of the additional SI from one or more broadcast messages from the 5G NR cell of the cellular wireless network during the second BCCH modification cycle,
wherein obtaining the updated values for at least one of the one of more of the additional SI occurs during a voice connection using the first SIM or eSIM.

6. (canceled)

7. The method of claim 1, further comprising:
determining updated values for one or more of the additional SI are not broadcast by the 5G NR cell of the cellular wireless network; and
obtaining the updated values for the one or more of the additional SI in response to one or more radio resource control (RRC) SI request messages sent to the 5G NR cell of the cellular wireless network.

8. The method of claim 7, further comprising:
sending the one or more RRC SI request messages as part of a random access channel (RACH) procedure while the first SIM or eSIM is in an RRC idle state or an RRC inactive state.

9. The method of claim 7, further comprising:
transitioning the first SIM or eSIM from a radio resource control (RRC) connected state for a data connection to an RRC idle state or an RRC inactive state prior to obtaining the updated values for the one or more of the additional SI.

10. The method of claim 7, further comprising:
transitioning the first SIM or eSIM from a radio resource control (RRC) connected state for a voice connection to an RRC idle state or an RRC inactive state prior to obtaining the updated values for the one or more of the additional SI.

11. The method of claim 1, wherein:
one or more of the updated values for the additional SI are obtained via broadcast messages received from the 5G NR cell of the cellular wireless network; and
one or more of the updated values for the additional SI are obtained responsive to radio resource control (RRC) SI request messages sent to the 5G NR cell of the cellular wireless network.

12. An apparatus configurable for operation in a wireless device, the apparatus comprising one or more processors coupled to a memory, the apparatus configured to perform actions for sharing system information (SI) updates for the wireless device, the actions including:
while the wireless device is connected to or camped on a fifth generation (5G) new radio (NR) cell of a cellular wireless network via a first subscriber identity module (SIM) or electronic SIM (eSIM) and via a second SIM or eSIM:
receiving, via the first SIM or eSIM, an SI change indication during a first broadcast control channel (BCCH) modification cycle;
receiving, via the first SIM or eSIM, and decoding an SI block (SIB) type one (SIB1) broadcast message during a second BCCH modification cycle;
determining additional SI require updating based on information included in the SIB1 broadcast message;
obtaining, via the first SIM or eSIM, updated values for the additional SI;
storing, in a memory shared with the second SIM or eSIM, the updated values for the additional SI; and
providing, to the second SIM or eSIM, an indication of availability of the updated values for the additional SI.

13. The apparatus of claim 12, wherein the first SIM or eSIM is a primary SIM or eSIM designated for data usage, when neither the first SIM or eSIM nor the second SIM or eSIM are connected to the 5G NR cell of the cellular wireless network via a voice connection.

14. The apparatus of claim 12, wherein the wireless device is connected to the 5G NR cell of the cellular wireless network via a voice connection using the first SIM or eSIM when the SI change indication is received.

15. The apparatus of claim 12, wherein determining the additional SI require updating comprises:
comparing value tags for the additional SI included in the SIB1 broadcast message to previously received and stored value tags for the additional SI; and
determining an SI requires updating when a value tag for the SI in the SIB1 broadcast message differs from a previously received and stored corresponding value tag for the SI.

16. The apparatus of claim 12, wherein the further comprise:
determining updated values for one or more of the additional SI are broadcast by the 5G NR cell of the cellular wireless network; and
obtaining the updated values for the one or more of the additional SI from one or more broadcast messages from the 5G NR cell of the cellular wireless network during the second BCCH modification cycle,
wherein the updated values for at least one of the one or more of the additional SI are obtained during a voice connection using the first SIM or eSIM.

17. (canceled)

18. The apparatus of claim 12, wherein the actions further comprise:
determining updated values for one or more of the additional SI are not broadcast by the 5G NR cell of the cellular wireless network; and
obtaining the updated values for the one or more of the additional SI in response to one or more radio resource control (RRC) SI request messages sent to the 5G NR cell of the cellular wireless network,
wherein the one or more RRC SI request messages are sent to the 5G NR cell of the cellular wireless network as part of a random access channel (RACH) procedure while the first SIM or eSIM is in an RRC idle state or an RRC inactive state.

19. (canceled)

20. The apparatus of claim 18, wherein the actions further comprise:
transitioning the first SIM or eSIM from a radio resource control (RRC) connected state for a data connection to an RRC idle state or an RRC inactive state prior to obtaining the updated values for the one or more additional SI.

21. The apparatus of claim 18, wherein the actions further comprise:
transitioning the first SIM or eSIM from a radio resource control (RRC) connected state for a voice connection to an RRC idle state or an RRC inactive state prior to obtaining the updated values for the one or more of the additional SI.

22. The apparatus of claim 12, wherein:
one or more of the updated values for the additional SI are obtained via broadcast messages received from the 5G NR cell of the cellular wireless network; and
one or more of the updated values for the additional SI are obtained responsive to radio resource control (RRC) SI request messages sent to the 5G NR cell of the cellular wireless network.

23. A wireless device comprising:
wireless circuitry comprising one or more antennas;
at least one processor communicatively coupled to the wireless circuitry and to memory storing instructions that when executed by the at least one processor cause the wireless device to perform actions for sharing system information (SI) updates, the actions including:
while connected to or camped on a fifth generation (5G) new radio (NR) cell of a cellular wireless network via a first subscriber identity module (SIM) or electronic SIM (eSIM) and via a second SIM or eSIM:
receiving, via the first SIM or eSIM, an SI change indication during a first broadcast control channel (BCCH) modification cycle;
receiving, via the first SIM or eSIM, and decoding an SI block (SIB) type one (SIB1) broadcast message during a second BBCH modification cycle;
determining additional SI require updating based on information included in the SIB1 broadcast message;
obtaining, via the first SIM or eSIM, updated values for the additional SI;
storing, in a memory shared with the second SIM or eSIM, the updated values for the additional SI; and
providing, to the second SIM or eSIM, an indication of availability of the updated values for the additional SI.

24. (canceled)
